(19) United States
(12) Patent Application Publication
(10) Pub. No.: US 2025/0260601 A1
(43) Pub. Date: Aug. 14, 2025

(54) METHOD AND APPARATUSES FOR ACQUIRING PILOT POSITION DETERMINATION MODEL, METHOD AND APPARATUSES FOR DETERMINING PILOT POSITION INFORMATION

(71) Applicant: Beijing Xiaomi Mobile Software Co., Ltd., Beijing (CN)

(72) Inventors: Liangang CHI, Beijing (CN); Haoxiang LIU, Beijing (CN)

(73) Assignee: Beijing Xiaomi Mobile Software Co., Ltd., Beijing (CN)

(21) Appl. No.: 18/857,730

(22) PCT Filed: Apr. 21, 2022
(86) PCT No.: PCT/CN2022/088321

§ 371 Date: Oct. 17, 2024

(51) Int. Cl. H04L 25/02; H04B 7/04; H04L 5/00

(52) U.S. Cl. CPC H04L 25/0224; H04L 5/0098; H04B 7/04013

(57) ABSTRACT

A method, device for acquiring a pilot position determination mode and computer readable storage medium in a wireless communication system. The pilot position determination model is obtained by: acquiring a training sample set, where the training sample set includes a plurality of sample groups; outputting first pilot position information by inputting the sample groups into an initial pilot position determination model; obtaining predicted channel state information based on the first pilot position information; and adjusting a model parameter of the initial pilot position determination model based on label channel state information and the predicted channel state information, and obtaining a target pilot position determination model by continuing training an adjusted initial pilot position determination model based on a next sample group until training ends.

### CROSS-REFERENCE TO RELATED APPLICATIONS

The present application is a U.S. National Stage of International Application No. PCT/CN2022/088321, filed on Apr. 21, 2022, the contents of all of which are incorporated herein by reference in their entirety for all purposes.

### BACKGROUND OF THE INVENTION

Requirements on radio communication technology vary with service types. For example, enhanced mobile broadband (eMBB) services place a higher priority on a large bandwidth, a high rate, etc. Ultra reliable low latency communication (URLLC) services place a higher priority on high reliability and low latency. Massive machine type of communication (mMTC) services place a higher priority on a massive connection number. Accordingly, a new generation of radio communication system requires a flexible and configurable design, so as to support the transmission requirements of various service types.

### SUMMARY OF THE INVENTION

The disclosure relates to the technical field of communication, and in particular to a method and an apparatus for acquiring a pilot position determination model, and a method and an apparatus for determining a pilot position information.

In a first aspect, a method for acquiring a pilot position determination model is provided in the examples of the disclosure. The method is performed by a communication device and includes: acquiring a training sample set, where the training sample set includes a plurality of sample groups, and each sample group includes first sample channel state information and label channel state information for the first sample channel state information; outputting first pilot position information by inputting the sample groups into an initial pilot position determination model; obtaining predicted channel state information based on the first pilot position information; and adjusting a model parameter of the initial pilot position determination model based on the label channel state information and the predicted channel state information, and obtaining a target pilot position determination model by continuing training an adjusted initial pilot position determination model based on a next sample group until training ends.

In a second aspect, a method for determining pilot position information is provided in an example of the disclosure. The method is performed by a communication device and includes:
acquiring an initial pilot signal, and determining first channel state information based on the initial pilot signal; and
obtaining target pilot position information of an RIS by inputting the first channel state information into a trained target pilot position determination model;
where the target pilot position determination model is obtained through training based on the method for acquiring a pilot position determination model.

In a third aspect, a method for determining pilot position information is provided in the examples of the disclosure. The method is performed by an RIS and includes:
transmitting an initial pilot signal to a communication device, where the initial pilot signal is configured to obtain first channel state information by performing channel estimation by the communication device, and target pilot position information of the RIS is obtained by inputting the first channel state information into a trained target pilot position determination mode.

In a fourth aspect, a communication apparatus is provided in the examples of the disclosure. The communication apparatus includes a processor and a memory, where the memory stores a computer program, and the processor causes the communication apparatus to execute the method in the first aspect by executing the computer program stored in the memory.

In a fifth aspect, a communication apparatus is provided in the examples of the disclosure. The communication apparatus includes a processor and a memory, where the memory stores a computer program, and the processor causes the communication apparatus to execute the method in the second aspect by executing the computer program stored in the memory.

In a sixth aspect, a communication apparatus is provided in the examples of the disclosure. The communication apparatus includes a processor and a memory, where the memory stores a computer program, and the processor causes the communication apparatus to execute the method in the third aspect by executing the computer program stored in the memory.

In a seventh aspect, a non-transitory computer-readable storage medium is provided in the examples of the disclosure. The computer-readable storage medium is configured to store an instruction used by the above reception device, where when executed, the instruction causes the reception device to execute the method in the first aspect.

In an eighth aspect, a non-transitory computer-readable storage medium is provided in the examples of the disclosure. The readable storage medium is configured to store an instruction used by the above transmission device, where when executed, the instruction causes the transmission device to execute method in the second aspect.

In a ninth aspect, a non-transitory computer-readable storage medium is provided in the examples of the disclosure. The readable storage medium is configured to store an instruction used by the above transmission device, where when executed, the instruction causes the transmission device to execute method in the third aspect.

### BRIEF DESCRIPTION OF DRAWINGS

In order to describe the technical solutions in examples of the disclosure or the background art more clearly, the accompanying drawings required to be used in the examples of the disclosure or the background art will be described below.

FIG. 1 is a schematic diagram of an architecture of a communication system according to an example of the disclosure;

FIG. 2 is a schematic flowchart of a method for acquiring a pilot position determination model according to an example of the disclosure;

FIG. 3 is a schematic diagram of arrangement of elements on the RIS according to an example of the disclosure;

FIG. 4 is a schematic flowchart of yet another method for acquiring a pilot position determination model according to an example of the disclosure;

FIG. 5 is a schematic flowchart of a method for determining pilot position information according to an example of the disclosure;

FIG. 6 is a schematic flowchart of yet another method for determining pilot position information according to an example of the disclosure;

FIG. 7 is a schematic flowchart of yet another method for determining pilot position information according to an example of the disclosure;

FIG. 8 is a schematic flowchart of yet another method for determining pilot position information according to an example of the disclosure;

FIG. 9 is a schematic flowchart of yet another method for determining pilot position information according to an example of the disclosure;

FIG. 10 is a schematic flowchart of still another method for determining pilot position information according to an example of the disclosure;

FIG. 11 is a structural diagram of a communication device according to an example of the disclosure;

FIG. 12 is a structural diagram of a communication apparatus according to an example of the disclosure; and

FIG. 13 is a structural diagram of a chip according to an example of the disclosure.

### DETAILED DESCRIPTION OF THE INVENTION

Examples will be described in detail here and illustratively shown in the accompanying drawings. When the following description relates to the accompanying drawings, the same numbers in different accompanying drawings denote the same or similar elements, unless indicated otherwise. Embodiments described in the following examples do not denote all embodiments consistent with the disclosure. On the contrary, the embodiments are merely instances of apparatuses and methods consistent with some aspects of the disclosure as recited in the appended claims.

The terms used in the examples of the disclosure are merely used to describe particular examples, rather than limit the examples of the disclosure. The singular forms “a,” “an,” and “the” used in the examples of the disclosure and the appended claims are also intended to include the plural forms, unless clearly stated in the context otherwise. It should also be understood that the term “and/or” used here indicates and encompasses one or any or all possible combinations of a plurality of associated items listed.

It should be understood that while the terms first, second, third, etc. can be employed in the examples of the disclosure to describe various information, these pieces of information should not be limited to this. These terms are merely used to distinguish between the same type of information. For example, first information can also be referred to as second information, and similarly, second information can also be referred to as first information, without departing from the scope of the examples of the disclosure. Depending on the context, the word “if” as used here can be interpreted as “at the time of,” “when,” or “in response to determining”.

For the sake of brevity and understanding, the terms “greater than” or “smaller than,” and “higher than” or “lower than” are used here to indicate magnitude relations. However, those skilled in the art can understand that the term “greater than” also covers the meaning of “greater than or equal to,” and the term “smaller than” also covers the meaning of “smaller than or equal to”; and the term “higher than” covers the meaning of “higher than or equal to,” and the term “lower than” also covers the meaning of “lower than or equal to”.

For ease of understanding, the terms involved in the disclosure are described first.

### 1, Reconfigurable Intelligence Surface (RIS)

The technical foundation of RIS is an artificial material called “information metamaterial”. The metamaterials are man-made materials having special properties and not existing in nature. They have some special properties, including allowing light and electromagnetic waves to change their general properties, which cannot be implemented by conventional materials. The RIS can improve the strength of a received signal and the transmission performance between communication devices by realizing signal propagation direction regulation and in-phase superposition in a three-dimensional space, while actively enriching a channel scattering condition and enhancing a multiplexing gain of a radio communication system.

In order to better understand a method and an apparatus for acquiring a pilot position determination model disclosed in the example of the disclosure, a communication system applicable to the example of the disclosure is first described below.

With reference to FIG. 1, FIG. 1 is a schematic diagram of an architecture of a communication system according to an example of the disclosure. The communication system may include, but is not limited to, one network device and one terminal device. Numbers and forms of the devices shown in FIG. 1 are merely illustrative, and do not limit the example of the disclosure. In practical application, two or more network devices and two or more terminal devices may be included. The communication system 100 shown in FIG. 1 includes one network device 101 and one terminal device 102 as an example.

It should be noted that the technical solution in the example of the disclosure may be applied to various communication systems. For example, the technical solution may be applied to a long term evolution (LTE) system, a 5th generation (5G) of mobile communication system, a 5G of new radio (NR) system, or other future novel mobile communication systems, etc. It should also be noted that a side link in the example of the disclosure may also be referred to as a sidelink.

The network device 101 in the example of the disclosure is an entity located on a network side and configured to transmit or receive signals. For example, the network device 101 may be an access network device. The access network device may be an evolved node b (enb), a transmission reception point (TRP), a next generation node b (gnb) in an NR system, a base station in other future mobile communication systems, or an access node in a wireless fidelity (wifi) system, etc. The network device 101 may be a core network device. The core network device in the example of the disclosure may be a device that communicates with the access network device. The core network device may be a 5G core network device, such as an access and mobility management function (AMF), or an evolved packet core (EPC) device, such as a mobility management entity (MME). The specific technology and the specific device form employed by the network device are not limited to the disclosure example. The network device according to the example of the disclosure, may be composed of a central unit (CU) and a distributed unit (DU), where the CU may also be referred to as a control unit. With a CU-DU structure employed, protocol layers of the network device, such as the base station, may be split, functions of some protocol layers are placed in the CU, so as to be centrally controlled, and functions of part or all of remaining protocol layers are distributed in the DU, and the DU is centrally controlled by the CU.

The terminal device 102 in the example of the disclosure is an entity located on a user side and configured to receive or transmit signals, such as a mobile phone. The terminal device may also be referred to as a terminal, user equipment (UE), a mobile station (MS), a mobile terminal (MT), etc. The terminal device may be a vehicle, smart vehicle, mobile phone, wearable device, and pad having a function of communication; and a computer, virtual reality (VR) terminal device, and augmented reality (AR) terminal device having a function of radio transceiving, radio terminal device in industrial control, radio terminal device in self-driving, radio terminal device in remote medical surgery, radio terminal device in smart grid, radio terminal device in transportation safety, radio terminal device in smart city, radio terminal device in smart home, etc. The specific technology and the specific device form employed by the terminal device are not limited in the example of the disclosure.

It can be understood that the communication system described in the example of the disclosure is intended to describe the technical solution in the example of the disclosure more clearly, instead of limiting the technical solution according to the example of the disclosure. As those of ordinary skill in the art know, with evolution of the system architecture and emergence of new service scenario, the technical solution according to the example of the disclosure is also applicable to similar technical problems.

In the related art, it is expected to break through the uncontrollability of a conventional radio channel, construct an intelligent programmable radio environment, and introduce a new paradigm of future radio communication by deploying a reconfigurable intelligence surface (RIS) on surfaces of various objects in a radio transmission environment. The RIS can improve the strength of a received signal and the transmission performance between communication devices by realizing signal propagation direction regulation and in-phase superposition in a three-dimensional space, while actively enriching a channel scattering condition and enhancing a multiplexing gain of the radio communication system. Thus, the RIS shows great potential for coverage enhancement and capacity improvement of a future radio network, and elimination of local coverage holes. It is a pressing issue to efficiently select effective elements on the RIS.

A method and an apparatus for acquiring a pilot position determination model, and a method and an apparatus for determining a pilot position information are provided in examples of the disclosure, and can be applied to the technical field of communication. Thus, the efficiency of determining channel state information of a pilot element on a reconfigurable intelligence surface (RIS) is improved by generating the pilot position determination model through training.

The method and the apparatus for acquiring a pilot position determination model provided by the disclosure are described in detail below with reference to the accompanying drawings.

With reference to FIG. 2, FIG. 2 is a schematic flowchart of a method for acquiring a pilot position determination model according to an example of the disclosure. As shown in FIG. 2, the method is performed by a communication device, and may include, but is not limited to following steps.

S21, a training sample set is acquired, where the training sample set includes a plurality of sample groups, and each sample group includes first sample channel state information and label channel state information for the first sample channel state information.

It should be noted that the communication device referred to in the example of the disclosure may be a network device or a terminal device. For example, the terminal device may be a mobile phone, a palmtop computer, etc., and the network device may be a base station, etc.

It should be noted that an RIS may be arranged between the network device and the terminal device, and has functions of transmitting a pilot signal, receiving a pilot signal, and estimating a pilot signal. The RIS can improve the strength of a received signal and the transmission performance between communication devices by realizing signal propagation direction regulation and in-phase superposition in a three-dimensional space, while actively enriching a channel scattering condition and enhancing a multiplexing gain of the radio communication system. Thus, the RIS shows great potential for coverage enhancement and capacity improvement of a future radio network, and elimination of local coverage holes.

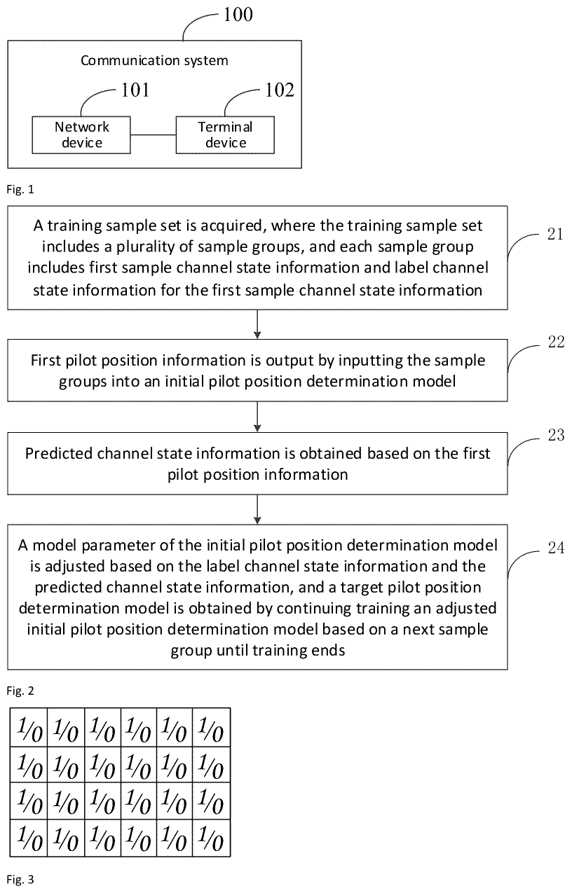

The RIS may include a plurality of pilot elements, and the elements on the RIS are arranged in a certain order, which is not limited here and may be specifically set according to practical demands or functions to be realized. For example, as shown in FIG. 3, the elements on the RIS may be arranged in a matrix. The pilot elements may be active elements, passive elements, or combinations of active elements and passive elements, and may be specifically set according to practical demands.

The active elements on the RIS may transmit the pilot signal, and channel state information (CSI), i.e. a channel attribute of a communication link in the field of radio communication may be obtained by performing estimation based on the pilot signal. The channel state information describes a fading factor of the signal on each transmission path, i.e. a value of each element in a channel gain matrix, such as signal scattering, fading (multipath fading or shadowing fading), and power decay of distance. It should be noted that CSI corresponding to each element may be the same or not.

After receiving the pilot signal transmitted by the pilot element on the RIS, the communication device may estimate channel state information H₁^{k} based on the pilot signal, and obtain the sample set based on the channel state information H₁^{k}. Optionally, the first sample channel state information H₁^{all} may be obtained as a plurality of samples in a training stage by enhancing a sample based on the channel state information H₁^{k} in a linear interpolation manner.

In the example of the disclosure, the label channel state information may be obtained in a set communication environment. For example, some channel state information may be obtained in an ideal transmission environment with less interference, and used as the label channel state information H^{real}.

It should be noted that the first sample channel state information corresponds one-to-one to the label channel state information, and the first sample channel state information and the corresponding label channel state information are taken as one sample group.

S22, first pilot position information is output by inputting the sample groups into an initial pilot position determination model.

In the example of the disclosure, the initial pilot position determination model may be an artificial intelligence (AI)/machine learning (ML) model. With considerable application potential in various aspects such as modeling and learning in complex unknown environment, channel predicting, intelligent signal generating and processing, network state tracking and intelligent scheduling, and network optimization deploying, the AI/ML model is expected to promote the evolution of future communication paradigms and the transformation of the network architecture, and thus has vital significance and value for 5G-advanced/6G technical research.

After obtaining the training sample set, the communication device inputs the sample groups (H₁^{all}, H^{real}) in the training sample set into the initial pilot position determination model in batches, and gradually extracts important features in an iterative process, in other words, selects a position having a largest pilot information amount as the first pilot position information (xₖ, yₖ), and save the first pilot position information. Specifically, k={1, 2, . . . , K}, where K denotes a number of sample groups selected in each batch, and also denotes a number of pilot elements to be activated on the RIS.

In an example, xₖ and yₖ indicate a time domain resource position and a frequency domain resource position allocated to the RIS or the pilot element on the RIS respectively. Thus, after the pilot position information (xₖ, yₖ) is obtained, the corresponding RIS or pilot element may be known according to the position information.

S23, predicted channel state information is obtained based on the first pilot position information.

After the first pilot position information is obtained, the communication device notifies the RIS of the obtained first pilot position information (xₖ, yₖ) through signaling. The pilot signal of the pilot element is activated by the RIS, and the predicted channel state information H^{pilot} is determined by estimating channel information at a selected pilot position by the communication device.

S24, a model parameter of the initial pilot position determination model is adjusted based on the label channel state information and the predicted channel state information, and a target pilot position determination model is obtained by continuing training an adjusted initial pilot position determination model based on a next sample group until training ends.

It can be understood that training to generate a model is a repeated iterative process. A network parameter of the model is continuously adjusted for training until a loss function value of an entire model is less than a preset value, and alternatively, a loss function value of an entire model does not change or changes slowly. Thus, the model converges to obtain a trained model.

After the label channel state information and the predicted channel state information are obtained, the model parameter is adjusted based on the label channel state information and the predicted channel state information, and an expected effect is reached by continuing training the adjusted initial pilot position determination model based on the next sample group.

Optionally, whether the expected effect is reached may be determined by acquiring the loss value and comparing the loss value with a set threshold. It should be noted that the set threshold may be pre-set.

Optionally, the accuracy of the predicted channel state information output by the model may be determined through a practical test. When the accuracy is greater than an accuracy threshold, it may be deemed that the expected effect is reached. It should be noted that the accuracy threshold may be pre-set.

In the example of the disclosure, the training sample set is acquired first, where the training sample set includes the plurality of sample groups, and each sample group includes the first sample channel state information and the label channel state information for the first sample channel state information; the first pilot position information is output by inputting the sample groups into the initial pilot position determination model; the predicted channel state information is obtained based on the first pilot position information; and the model parameter of the initial pilot position determination model is adjusted based on the label channel state information and the predicted channel state information, and the target pilot position determination model is obtained by continuing training the adjusted initial pilot position determination model based on the next sample group until training ends. Thus, the efficiency of determining channel state information of the pilot element on the RIS can be improved by training the initial pilot position determination model. Especially when there are a large number of pilot elements on the RIS, a time cost of performing channel estimation by the communication device can be saved on, and an accuracy rate can be increased.

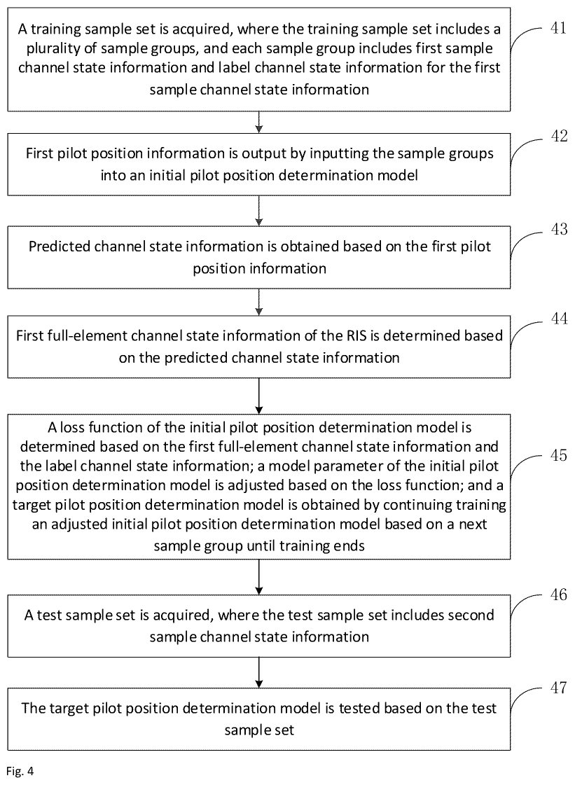

With reference to FIG. 4, FIG. 4 is a schematic flowchart of a method for acquiring a pilot position determination model according to an example of the disclosure. As shown in FIG. 4, the method is performed by a communication device, and may include, but is not limited to following steps.

S41, a training sample set is acquired, where the training sample set includes a plurality of sample groups, and each sample group includes first sample channel state information and label channel state information for the first sample channel state information.

It should be noted that the communication device referred to in the example of the disclosure may be a network device or a terminal device. For example, the terminal device may be a mobile phone, a palmtop computer, etc., and the network device may be a base station, etc.

Reference may be made to the description of relevant contents in the above example for the description of the training sample set, which will not be repeated here.

S42, first pilot position information is output by inputting the sample groups into an initial pilot position determination model.

The embodiment according to any example of the disclosure may be employed for the embodiment of S42, which will not be repeated here.

S43, predicted channel state information is obtained based on the first pilot position information.

Optionally, after the first pilot position information is obtained, a first pilot element, indicated by the first pilot position information, on an RIS is activated, a first pilot signal transmitted by the first pilot element is received, and the predicted channel state information is obtained by performing channel estimation based on the first pilot signal.

Optionally, the communication device is the network device in a scenario of uplink transmission, the first pilot element is activated by the network device based on a first pilot position.

In some embodiments, the RIS is instructed to activate the first pilot element by transmitting the first pilot position information to the RIS by the network device through signaling. Alternatively, the first pilot element is determined by the network device based on the first pilot position information, and an activation instruction is transmitted to the RIS, where the activation instruction is configured to instruct to activate the first pilot element.

Optionally, the communication device is the terminal device in a scenario of downlink transmission, the first pilot position information is transmitted to the network device by the terminal device through uplink signaling, where the first pilot element is activated by the network device based on the first pilot position.

S44, first full-element channel state information of the RIS is determined based on the predicted channel state information.

In the example of the disclosure, after the predicted channel information is obtained, an active element on the RIS may be determined based on the predicted channel information. After the active element is determined, channel state information of other elements may be determined based on a position of the active element on the RIS. It should be noted that the first full-element channel state information may be determined through various methods. For example, it may be determined through a conventional difference algorithm, and may be screened and determined through a neural network algorithm, which is not limited here.

S45, a loss function of the initial pilot position determination model is determined based on the first full-element channel state information and the label channel state information; a model parameter of the initial pilot position determination model is adjusted based on the loss function; and a target pilot position determination model is obtained by continuing training an adjusted initial pilot position determination model based on a next sample group until training ends.

A loss value may be generated by calculating the loss function of the initial pilot position determination model according to the first full-element channel state information and the label channel state information. For example, the loss function in the example is pre-set, and may be set according to practical demands. For example, the loss function may be a hinge loss function, a cross-entropy loss function, an exponential loss function, etc., which may be specifically selected according to practical demands, and is not limited here.

Further, the initial pilot position determination model is adjusted through the loss value. The target pilot position determination model is generated by training the adjusted initial pilot position determination model according to the above steps until training ends. Optionally, after the loss value reaches a loss threshold, training is completed, and the target pilot position determination model is generated. The loss threshold may be set according to a practical situation.

S46, a test sample set is acquired, where the test sample set includes second sample channel state information.

In the example of the disclosure, the channel state information H₃^{k} may be estimated based on the pilot signal, the test sample set is obtained in a linear interpolation manner, and then the second sample channel state information is obtained.

It should be noted that there may be duplicate samples in the test sample set and above training sample set, or there may be a certain proportion between numbers of the duplicate samples and completely different samples, which is not limited here, and may be set according to practical demands.

The loss function in the example is pre-set, and may be set according to practical demands. For example, the loss function may be a hinge loss function, a cross-entropy loss function, an exponential loss function, etc., which may be specifically selected according to practical demands, and is not limited here.

S47, the target pilot position determination model is tested based on the test sample set.

After the test sample set and the second sample channel state information are obtained, the performance of the target pilot position determination model is checked through the test sample set, a weight is continuously adjusted through data and labels, and the model is saved locally to the network device after the parameter is updated.

In the example of the disclosure, the test sample set is acquired first, where the test sample set includes the second sample channel state information. Then, the target pilot position determination model is tested based on the test sample set. Thus, the accuracy and practicability of the target pilot position determination model can be improved by testing the target pilot position determination model.

In the example of the disclosure, the training sample set is acquired first, where the training sample set includes the plurality of sample groups, and each sample group includes the first sample channel state information and the label channel state information for the first sample channel state information; then, the first pilot position information is output by inputting the sample groups into the initial pilot position determination model; the predicted channel state information is obtained based on the first pilot position information; the first full-element channel state information of the RIS is determined based on the predicted channel state information; the loss function of the initial pilot position determination model is determined based on the first full-element channel state information and the label channel state information; the model parameter of the initial pilot position determination model is adjusted based on the loss function; the target pilot position determination model is obtained by continuing training the adjusted initial pilot position determination model based on the next sample group until training ends; the test sample set is acquired, where the test sample set includes the second sample channel state information; and finally, the target pilot position determination model is tested based on the test sample set. Thus, the target pilot position determination model is generated through training, and the target pilot positions of all the elements on the RIS may be acquired by inputting the data. Thus, the efficiency of determining channel state information of the pilot elements on the RIS is greatly improved, a time cost is saved on, and the accuracy is improved.

With reference to FIG. 5, FIG. 5 is a schematic flowchart of a method for determining pilot position information according to an example of the disclosure. As shown in FIG. 5, the method is performed by a communication device, and may include, but is not limited to following steps.

S51, an initial pilot signal is acquired, and first channel state information is determined based on the initial pilot signal.

It should be noted that the communication device referred to in the example of the disclosure may be a network device or a terminal device. For example, the terminal device may be a mobile phone, a palmtop computer, etc., and the network device may be a base station, etc.

In the example of the disclosure, the first channel state information H₂^{k} may be obtained by receiving an initial pilot signal transmitted by an initial pilot element activated on an RIS and estimating a practical pilot signal by the communication device in a practical environment. Optionally, the initial pilot element may be determined in real time, or may be pre-defined or pre-configured. Optionally, the first channel state information may be received in real time, or may be previously received.

S52, target pilot position information of the RIS is obtained by inputting the first channel state information into a trained target pilot position determination model.

In the example of the disclosure, the first channel state information H₂^{k} is input into the target pilot position determination model by the network device or the terminal device, and the target pilot position information (xₘ, yₘ) is output from the target pilot position determination model.

In an example, xₘ and yₘ indicate a time domain resource position and a frequency domain resource position allocated to the RIS or the pilot element on the RIS respectively. Thus, after the pilot position information (xₘ, yₘ) is obtained, the corresponding RIS or pilot element may be known according to the position information.

Reference may be made to contents in the above example for a method for training the target pilot position determination model, which will not be repeated here.

In the example of the disclosure, the first channel state information is determined. Then, the target pilot position information of the RIS is obtained by inputting the first channel state information into the trained target pilot position determination model. Thus, the target pilot position information of the RIS is obtained by inputting the first channel state information into the target pilot position determination model. Accordingly, the accuracy and efficiency of obtaining the target pilot position information can be improved, and an obtaining time cost can be reduced.

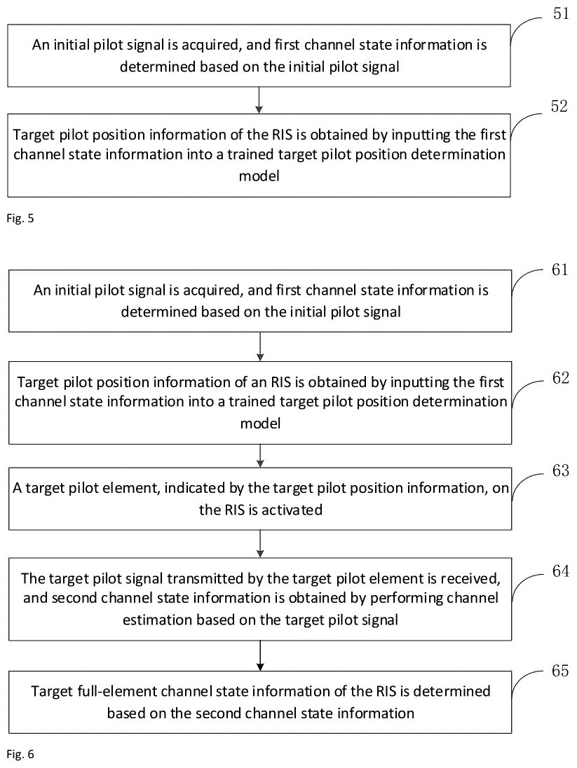

With reference to FIG. 6, FIG. 6 is a schematic flowchart of a method for determining a pilot position information according to an example of the disclosure. As shown in FIG. 6, the method is performed by a communication device, and may include, but is not limited to following steps.

S61, an initial pilot signal is acquired, and first channel state information is determined based on the initial pilot signal.

It should be noted that the communication device referred to in the example of the disclosure may be a network device or a terminal device. For example, the terminal device may be a mobile phone, a palmtop computer, etc., and the network device may be a base station, etc.

S62, target pilot position information of an RIS is obtained by inputting the first channel state information into a trained target pilot position determination model.

The embodiment according to any example of the disclosure may be employed for the embodiments of S61-S62, which will not be repeated here.

S63, a target pilot element, indicated by the target pilot position information, on the RIS is activated.

After the target pilot position information is determined, the target pilot element, indicated by the target pilot position information, on the RIS may be activated, so that a target pilot signal is transmitted to the communication device through the target pilot element.

The communication device is the network device in a scenario of uplink transmission, the target pilot element may be directly activated by the network device based on the target pilot position information. The communication device is the terminal device in a scenario of downlink transmission, the target pilot position information is required to be reported to the network device by the terminal device. The target pilot element, indicated by the target pilot position information, on the RIS is activated by the network device.

S64, the target pilot signal transmitted by the target pilot element is received, and second channel state information is obtained by performing channel estimation based on the target pilot signal.

In the example of the disclosure, after receiving the target pilot signal transmitted by the target pilot element, the communication device may obtain the second channel state information by performing the channel estimation on the target pilot signal.

S65, target full-element channel state information of the RIS is determined based on the second channel state information.

In the example of the disclosure, after the second channel state information is obtained, an active element on the RIS may be determined based on the second channel state information. After the active element is determined, the target full-element channel state information may be determined by determining channel state information of other elements based on a position of the active element on the RIS.

It should be noted that various methods may be employed to recover channel information at a target pilot position into channel information corresponding to every element of the RIS. For example, the channel information may be recovered through a conventional difference algorithm, and may also be filtered through a neural network algorithm, which is not limited here.

In the example of the disclosure, after the target pilot position information is obtained, the target pilot element, indicated by the target pilot position information, on the RIS may also be activated.

The method for determining a pilot position information according to the example of the disclosure is described in the scenario of uplink transmission and the scenario of downlink transmission separately below.

With reference to FIG. 7, FIG. 7 is a schematic flowchart of a method for determining a pilot position information according to an example of the disclosure. In the scenario of uplink transmission, as shown in FIG. 7, the method is performed by a network device, and may include, but is not limited to following steps.

S71, an initial pilot signal is acquired by the network device, and first channel state information is determined based on the initial pilot signal.

S72, target pilot position information of an RIS is obtained by the network device by inputting the first channel state information into a trained target pilot position determination model.

The embodiment according to any example of the disclosure may be employed for the embodiments of S71-S72, which will not be repeated here.

S73, a target pilot element is activated by the network device based on the target pilot position information.

Optionally, the RIS is instructed to activate the target pilot element by transmitting the target pilot position information to the RIS by the network device through first signaling. Optionally, the target pilot element is determined by the network device based on the target pilot position information, and an activation instruction is transmitted to the RIS, where the activation instruction is configured to instruct to activate the target pilot element.

S74, a target pilot signal transmitted by the target pilot element is received by the network device, and second channel state information is obtained by performing channel estimation based on the target pilot signal.

Reference may be made to the description of relevant contents in the above example for the step that second channel state information is obtained by performing channel estimation based on the target pilot signal, which will not be repeated here.

S75, target full-element channel state information of the RIS is determined by the network device based on the second channel state information.

Reference may be made to the description of relevant contents in the above example for the step that targets full-element channel state information of the RIS, which is determined based on the second channel state information, which will not be repeated here.

In the scenario of uplink transmission, the first channel state information is determined by the base station; the target pilot position information of the RIS is obtained by inputting the first channel state information into the trained target pilot position determination model; then, the target pilot element is activated based on the target pilot position information; the target pilot signal transmitted by the target pilot element is received by the network device; the second channel state information is obtained by performing the channel estimation based on the target pilot signal; the target full-element channel state information of the RIS is determined by the network device based on the second channel state information; and all elements of the RIS are re-configured based on the target full-element channel state information.

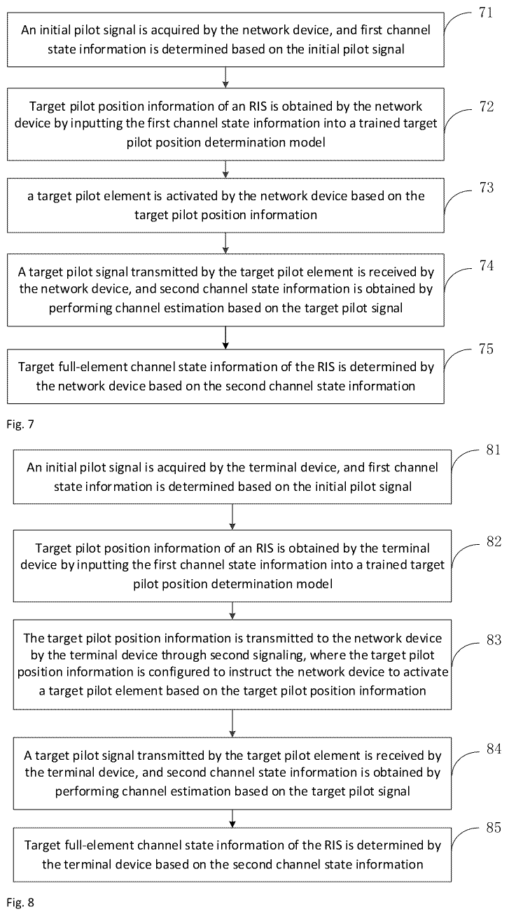

With reference to FIG. 8, FIG. 8 is a schematic flowchart of a method for determining a pilot position information according to an example of the disclosure. In the scenario of downlink transmission, as shown in FIG. 8, the method is performed by the terminal device, and may include, but is not limited to following steps.

S81, an initial pilot signal is acquired by the terminal device, and first channel state information is determined based on the initial pilot signal.

S82, target pilot position information of an RIS is obtained by the terminal device by inputting the first channel state information into a trained target pilot position determination model.

S83, the target pilot position information is transmitted to the network device by the terminal device through second signaling, where the target pilot position information is configured to instruct the network device to activate a target pilot element based on the target pilot position information.

In the example of the disclosure, the terminal device does not communicate with the RIS directly. After obtained through the target pilot position determination model, the target pilot position information is transmitted to the network device through second signaling, and the network device communicates with the RIS to activate the target pilot element.

S84, a target pilot signal transmitted by the target pilot element is received by the terminal device, and second channel state information is obtained by performing channel estimation based on the target pilot signal.

Reference may be made to the description of relevant contents in the above example for the step that second channel state information is obtained by performing channel estimation based on the target pilot signal, which will not be repeated here.

S85, target full-element channel state information of the RIS is determined by the terminal device based on the second channel state information.

Reference may be made to the description of relevant contents in the above example for the step that targets full-element channel state information of the RIS, which is determined based on the second channel state information, which will not be repeated here.

With reference to FIG. 9, FIG. 9 is a schematic flowchart of a method for determining pilot position information according to an example of the disclosure. As shown in FIG. 9, the method is performed by an RIS, and may include, but is not limited to following steps.

S91, an initial pilot signal is transmitted to a communication device, where the initial pilot signal is configured to obtain first channel state information by performing channel estimation by the communication device, and target pilot position information of the RIS is obtained by inputting the first channel state information into a trained target pilot position determination model.

Reference may be made to contents in the above example for a method for training the target pilot position determination model, which will not be repeated here.

In the example of the disclosure, the initial pilot signal is transmitted to the network device by the RIS through an initially-activated pilot element, and the first channel state information is obtained by performing initial pilot signal estimation by the network device. Then, the target pilot position information of the RIS is obtained by inputting the first channel state information into the trained target pilot position determination model. It should be noted that the network device may be a base station.

It should be noted that the initial pilot signal may be transmitted to the communication device through an activated initial pilot element on the RIS.

After the target pilot position information is obtained, activation configuration information may be generated based on the target pilot position information, an active element on the RIS may be re-configured based on the activation configuration information, the pilot signal is transmitted to the base station by activating a designated pilot element of the RIS, and the target pilot signal is transmitted to the communication device based on the target pilot element, where the target pilot signal is configured to obtain the second channel state information by performing the channel estimation.

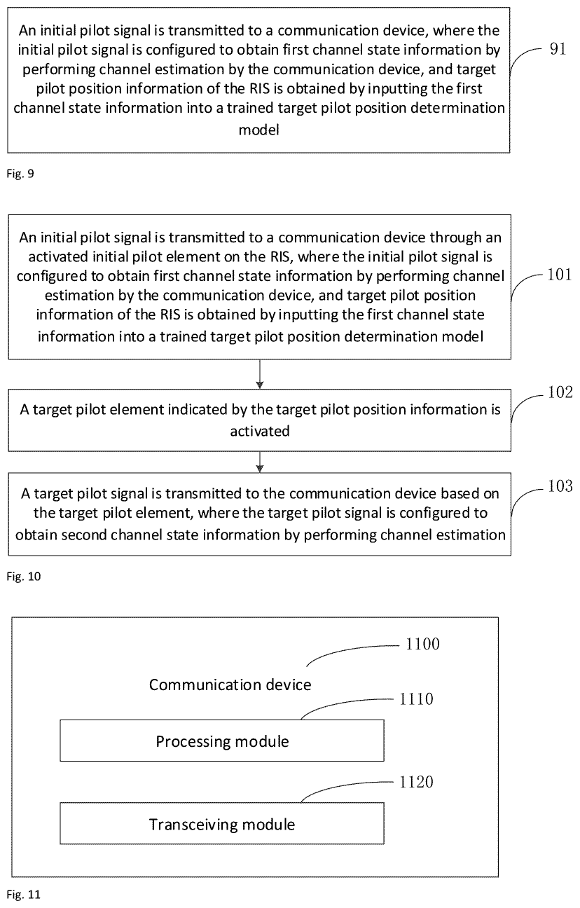

With reference to FIG. 10, FIG. 10 is a schematic flowchart of a method for determining pilot position information according to an example of the disclosure. As shown in FIG. 10, the method is performed by an RIS, and may include, but is not limited to following steps.

S101, an initial pilot signal is transmitted to a communication device through an activated initial pilot element on the RIS, where the initial pilot signal is configured to obtain first channel state information by performing channel estimation by the communication device, and target pilot position information of the RIS is obtained by inputting the first channel state information into a trained target pilot position determination model.

Reference may be made to the description of relevant contents in the above example for the step that target pilot position information of the RIS is obtained based on the initial pilot signal, which will not be repeated here.

S102, a target pilot element indicated by the target pilot position information is activated.

Optionally, activation configuration information is received, an active element of the RIS is re-configured based on the activation configuration information, and the target pilot element is activated.

Optionally, the communication device is a network device in a scenario of uplink transmission, the target pilot element is activated by the network device based on the target pilot position information.

Optionally, the communication device is a terminal device in a scenario of downlink transmission, the target pilot position information is transmitted to a network device by the terminal device through second signaling, where the target pilot position information is configured to instruct the network device to activate the target pilot element based on the target pilot position information.

S103, a target pilot signal is transmitted to the communication device based on the target pilot element, where the target pilot signal is configured to obtain second channel state information by performing channel estimation.

Reference may be made to the description of relevant contents in the above example for the step that a target pilot signal is transmitted to the communication device based on the target pilot element, where the target pilot signal is configured to obtain second channel state information by performing channel estimation, which will not be repeated here.

In the above example of disclosure, the method, according to the example of disclosure, is described separately from the perspectives of the terminal device and the network device. In order to implement all the functions in the method according to the example of the disclosure, the terminal device and the network device may each include a hardware structure and a software module, and implement all the above functions in a form of the hardware structure, the software module, or the hardware structure plus the software module. One of all the above functions may be performed in a form of the hardware structure, the software module, or the hardware structure plus the software module.

With reference to FIG. 11, a schematic structural diagram of a communication device 1100 according to an example of the disclosure is shown. The communication device 1100 shown in FIG. 11 may include a processing module 1110 and a transceiving module 1120.

The communication device 1100 may be a terminal device, a device in a terminal device, an RIS, or a device that may be used in conjunction with a terminal device or a network device.

The communication device 1100 includes a processing module 1110.

The processing module 1110 configured to acquire a training sample set, where the training sample set includes a plurality of sample groups, and each sample group includes first sample channel state information and label channel state information for the first sample channel state information; output first pilot position information by inputting the sample groups into an initial pilot position determination model; obtain predicted channel state information based on the first pilot position information; and adjust a model parameter of the initial pilot position determination model based on the label channel state information and the predicted channel state information, and obtain a target pilot position determination model by continuing training an adjusted initial pilot position determination model based on a next sample group until training ends.

Optionally, the processing module 1110 is further configured to activate a first pilot element, indicated by the first pilot position information, on the reconfigurable intelligence surface (RIS); and receive a first pilot signal transmitted by the first pilot element, and obtain the predicted channel state information by performing channel estimation based on the first pilot signal.

Optionally, the processing module 1110 is further configured to acquire a test sample set, where the test sample set includes second sample channel state information; and test the target pilot position determination model based on the test sample set.

Optionally, the processing module 1110 is further configured to determine first full-element channel state information of the RIS based on the predicted channel state information; determine a loss function of the initial pilot position determination model based on the first full-element channel state information and the label channel state information; and adjust the model parameter of the initial pilot position determination model based on the loss function.

After determining the target pilot position determination model, optionally, the processing module 1110 is further configured to acquire an initial pilot signal; determine first channel state information based on the initial pilot signal; and obtain target pilot position information of the RIS by inputting the first channel state information into a trained target pilot position determination model; where the target pilot position determination model is obtained through training based on the acquisition method in any example described above.

Optionally, the processing module 1110 is further configured to activate a target pilot element, indicated by the target pilot position information, on the RIS.

Optionally, the communication device is the network device in a scenario of uplink transmission, the processing module 1110 is further configured to activate the target pilot element by the network device based on the target pilot position information.

Optionally, the processing module 1110 is further configured to instruct the RIS to activate the target pilot element by transmitting the first pilot position information to the RIS through first signal; and alternatively, determine the target pilot element based on the target pilot position information, and transmit an activation instruction to the RIS, where the activation instruction is configured to instruct to activate the target pilot element.

Optionally, the processing module 1110 is further configured to receive a target pilot signal transmitted by the target pilot element, and obtain second channel state information by performing channel estimation based on the target pilot signal.

Optionally, the processing module 1110 is further configured to determine target full-element channel state information of the RIS based on the second channel state information.

The communication device 1100 may also be the RIS (as the RIS in the foregoing method example).

The transceiving module 1120 is further configured to transmit an initial pilot signal to the terminal device or the network device, where the initial pilot signal is configured to obtain first channel state information by performing channel estimation by the communication device; and obtain target pilot position information of the RIS by inputting the first channel state information into a trained target pilot position determination model.

Optionally, the transceiving module 1120 is further configured to transmit the initial pilot signal to the terminal device or the network device through an activated initial pilot element on the RIS.

Optionally, the processing module 1110 is further configured to activate a target pilot element indicated by the target pilot position information.

The transceiving module 1120 is further configured to receive activation configuration information, re-configure an active element of the RIS based on the activation configuration information, and activate the target pilot element.

Optionally, the transceiving module 1120 is further configured to transmit a target pilot signal to the communication device based on the target pilot element, where the target pilot signal is configured to obtain second channel state information by performing channel estimation.

In the example of the disclosure, the efficiency of determining channel state information of the pilot element on the RIS can be improved by training the initial pilot position determination model. Especially when there are a large number of pilot elements on the RIS, a time cost of performing channel estimation by the communication device can be saved on, and an accuracy rate can be increased.

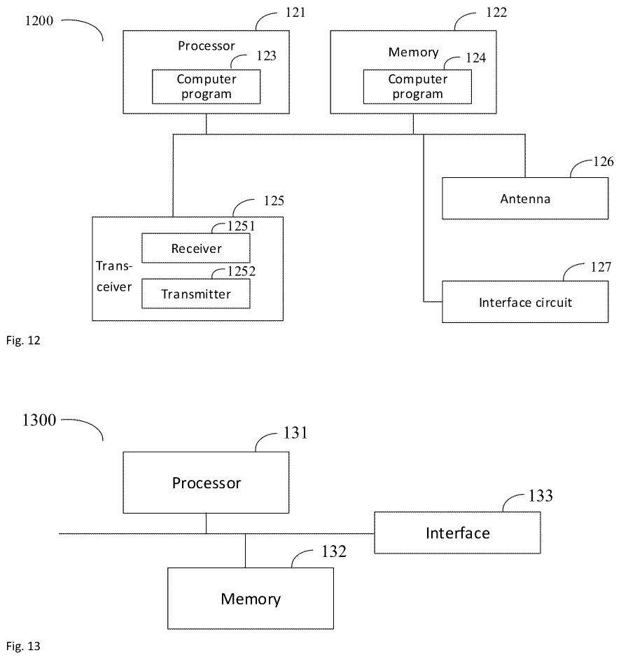

With reference to FIG. 12, FIG. 12 is a schematic structural diagram of another communication apparatus 1200 according to an example of the disclosure. The communication apparatus 1200 may be a network device, a terminal device, and an RIS; a chip, a chip system, a processor, etc. that supports the network device in implementing the above method; and a chip, a chip system, a processor, etc. that supports the terminal device in implementing the above method. The apparatus may be configured to implement the method described in the above method example, and reference may be made to the description in the above method example for details.

The communication apparatus 1200 may include one or more processors 121. The processor 121 may be a general-purpose processor, a special-purpose processor, etc. For example, the processor may be a baseband processor or a central processing unit. The baseband processor may be configured to process communication protocols and communication data. The central processing unit may be configured to control the communication apparatus (such as a base station, baseband chip, the terminal device, a terminal device chip, the DU, and the CU), execute a computer program, and process data of the computer program.

Optionally, the communication apparatus 1200 may further include one or more memories 122, where the memory stores a computer program 124, the processor 121 causes the communication apparatus 1200 to execute the method described in the above method example by executing the computer program 124. Optionally, the memory 122 may also store data. The communication apparatus 1200 and the memory 122 may be arranged separately or integrated together.

Optionally, the communication apparatus 1200 may further include a transceiver 125 and an antenna 126. The transceiver 125 may be referred to as a transceiving unit, a transceiving machine, or a transceiving circuit, etc., and is configured to implement a transceiving function. The transceiver 125 may include a receiver 1251 and a transmitter 1252, where the receiver 1251 may be referred to as a reception machine or reception circuit, etc., and is configured to implement a reception function; and the transmitter 1252 may be referred to as a transmission machine or a transmission circuit, etc., and is configured to implement a transmission function.

Optionally, the communication apparatus 1200 may further include one or more interface circuits 127. The interface circuit 127 is configured to receive a code instruction, and transmit same to the processor 121. The processor 121 causes the communication apparatus 1200 to execute the method described in the above method example by running the code instruction.

In an embodiment, the processor 121 may include a transceiver configured to implement functions of reception and transmission. For example, the transceiver may be a transceiving circuit, an interface, or an interface circuit. The transceiving circuit, interface, or interface circuit configured to implement the functions of reception and transmission may be separated or integrated together. The above transceiving circuit, interface, or interface circuit may be configured to read and write codes/data. Alternatively, the above transceiving circuit, interface, or interface circuit may be configured to transmit or transfer a signal.

In an embodiment, the processor 121 may store a computer program 123, where when run on the processor 121, the computer program 123 may cause the communication apparatus 1200 to execute the method described in the above method example. The computer program 123 may be firmed in the processor 121. In this case, the processor 121 may be implemented by hardware.

In an embodiment, the communication apparatus 1200 may include a circuit, where the circuit may implement the function of transmission, reception, or communication in the foregoing method example. The processor and the transceiver described in the disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be fabricated through various IC process technologies, such as a complementary metal oxide semiconductor (CMOS), an nmetal-oxide-semiconductor (NMOS), a positive channel metal oxide semiconductor (PMOS), a bipolar junction transistor (BJT), a bipolar CMOS (bicmos), silicon germanium (sige), and gallium arsenide (gaas).

The communication apparatus described in the above example may be the network device or the terminal device (as the terminal device in the foregoing method example), but the scope of the communication apparatus described in the disclosure is not limited to this. The structure of the communication apparatus may not be limited by FIG. 12. The communication apparatus may be a stand-alone device or a part of a large device. For example, the communication apparatus may be:
(1) an independent integrated circuit (IC), a chip, a chip system, or a chip subsystem;
(2) a set having one or more ICs, which may optionally include a storage component configured to store data and the computer program;
(3) an ASIC, such as a modem;
(4) a module, which may be embedded in other devices;
(5) a receiver, a terminal device, a smart terminal device, a cellular phone, a radio device, a handset, a mobile unit, a vehicle-mounted device, a network device, a cloud device, an artificial intelligence device, etc.; and
(6) a different apparatus, etc.

Reference may be made to the schematic structural diagram of a chip shown in FIG. 13 for the case where the communication apparatus may be the chip or the chip system. The chip shown in FIG. 13 includes a processor 131 and an interface 132. One or more processors 131 may be provided, and a plurality of interfaces 132 may be provided.

The chip is configured to implement any method according to the example of the disclosure.

Optionally, the chip further includes a memory 133, where the memory 133 is configured to store the necessary computer program and data.

Those skilled in the art can also appreciate that various illustrative logical blocks and steps set forth in the example of the disclosure may be implemented through electronic hardware, computer software, or combinations of both. Whether such functions are implemented through the hardware or the software depends on the particular application and overall system design requirements. Those skilled in the art can use the functions implemented in various methods for each particular application, but such an implementation should not be interpreted as exceeding the scope of protection of the examples of the disclosure.

The disclosure further provides a readable storage medium. The readable storage medium stores an instruction, where when executed by a computer, the instruction implements the functions of any method example described above.

The disclosure further provides a computer program product. When executed by a computer, the computer program product implements the functions in any method example described above.

In the above example, some or all of the functions may be implemented through software, hardware, firmware, or their any combinations. When implemented through the software, some or all of the functions may be implemented in a form of the computer program product. The computer program product includes one or more computer programs. When loaded and executed on a computer, some or all of the computer programs generate the flows or functions according to the example of the disclosure. The computer can be a general-purpose computer, a special-purpose computer, a computer network, or another programmable device. The computer program can be stored in a computer-readable storage medium, or transmitted from one computer-readable storage medium to another computer-readable storage medium, for example, from one website, computer, server, or data center to another website, computer, server, or data center through a wired means (for example, a coaxial cable, an optical fiber, and a digital subscribe line (DSL)), or a radio means (for example, infrared, radio waves, and microwaves). The computer-readable storage medium can be any available medium that a computer can access, or an integrated server, data center, etc. encompassing one or more available media. The available medium can be a magnetic medium (for example, a floppy disk, a hard disk, or a tape), an optical medium (for example, a digital video disk (DVD)), a semiconductor medium (for example, a solid state disk (SSD)), etc.

Those of ordinary skill in the art can understand that various numerical numbers such as first and second involved in the disclosure are merely for convenience of description, instead of limiting the scope of the examples of the disclosure, and also indicate a successive sequence.

At least one of in the disclosure can also be described as one or more, and a plurality of can indicate two, three, four, or more, which is not limited in the disclosure. In the examples of the disclosure, technical features in a kind of technical features are distinguished by “first,” “second,” “third,” “A,” “B,” “C,” and “D,” and there is no successive sequence or magnitude sequence among technical features described by “first,” “second,” “third,” “A,” “B,” “C,” and “D”.

Correspondence relations shown in each table of the disclosure can be configured or pre-defined. Values of information in each table are merely illustrative, and can be configured as other values, which is not limited in the disclosure. When a correspondence relation between the information and each parameter is configured, it is not necessarily required to configure all the correspondence relations indicated in each table. For example, in the table of the disclosure, the corresponding relations shown in some rows may not be configured. For another example, appropriate deformation and adjustment, such as splitting and merging, can be made based on the above table. The name of the parameter shown in the title of each table can also employ other names that are understandable by the communication apparatus, and the value or expression mode of the parameter can also employ other values or expression modes that are understandable by the communication apparatus. When implemented, each table can also employ other data structures, such as an array, a queue, a container, a stack, a linear table, a pointer, a linked list, a tree, a graph, a structural body, a class, a heap, a hash table, and a hash table.

Pre-defining in the disclosure can be interpreted as defining, pre-defining, storing, pre-storing, pre-negotiating, pre-configuring, firming, or pre-firing.

Those of ordinary skill in the art can appreciate that the units and algorithm steps of all instances described in combination with the examples disclosed here can be implemented through electronic hardware, or combinations of computer software and electronic hardware. Whether these functions are performed through hardware or software depends on the particular application of the technical solution and design constraint conditions. Those skilled in the art can implement the functions described through different methods for each particular application, but such an implementation should not be deemed as exceeding the scope of the disclosure.

Those skilled in the art can clearly understand that for convenience and brevity of description, reference can be made to the corresponding processes in the foregoing method example for specific operating processes of the above system, apparatus, and unit, which will not be repeated here.

What are described above are merely the particular embodiments of the disclosure, but the scope of protection of the disclosure is not limited to this. Changes or substitutions that can be readily conceived by those skilled in the art within the technical scope disclosed by the disclosure should fall within the scope of protection of the disclosure. Thus, the scope of protection of the disclosure should be defined by the scope of protection of the claims.

1. A method for acquiring a pilot position determination model, performed by a communication device, comprising:
acquiring a training sample set, wherein the training sample set comprises a plurality of sample groups, and each sample group comprises first sample channel state information and label channel state information for the first sample channel state information;
outputting first pilot position information by inputting the sample groups into an initial pilot position determination model;
obtaining predicted channel state information based on the first pilot position information; and
adjusting a model parameter of the initial pilot position determination model based on the label channel state information and the predicted channel state information, and obtaining a target pilot position determination model by continuing training an adjusted initial pilot position determination model based on a next sample group until training ends.

2. The method according to claim 1, wherein obtaining the predicted channel state information based on the first pilot position information comprises:
activating a first pilot element, indicated by the first pilot position information, on a reconfigurable intelligence surface (RIS); and
receiving a first pilot signal transmitted by the first pilot element, and obtaining the predicted channel state information by performing channel estimation based on the first pilot signal.

3. The method according to claim 1, wherein after obtaining the target pilot position determination model, the method further comprises:
acquiring a test sample set, wherein the test sample set comprises second sample channel state information; and
testing the target pilot position determination model based on the test sample set.

4. The method according to claim 1, wherein adjusting the model parameter of the initial pilot position determination model based on the label channel state information and the predicted channel state information comprises:
determining first full-element channel state information of an RIS based on the predicted channel state information;
determining a loss function of the initial pilot position determination model based on the first full-element channel state information and the label channel state information; and
adjusting the model parameter of the initial pilot position determination model based on the loss function.

5. A method for determining pilot position information, performed by a communication device, comprising:
acquiring an initial pilot signal, and determining first channel state information based on the initial pilot signal; and
obtaining target pilot position information of an RIS by inputting the first channel state information into a trained target pilot position determination model;
wherein
the trained target pilot position determination model is obtained through training based on a method for acquiring a pilot position determination model that includes:
acquiring a training sample set, wherein the training sample set comprises a plurality of sample groups, and each sample group comprises first sample channel state information and label channel state information for the first sample channel state information;
outputting first pilot position information by inputting the sample groups into an initial pilot position determination model;
obtaining predicted channel state information based on the first pilot position information;
adjusting a model parameter of the initial pilot position determination model based on the label channel state information and the predicted channel state information, and
obtaining the trained target pilot position determination model by continuing training an adjusted initial pilot position determination model based on a next sample group until training ends.

6. The method according to claim 5, wherein after obtaining the target pilot position information, the method further comprises:
activating a target pilot element, indicated by the target pilot position information, on the RIS.

7. The method according to claim 6, wherein the communication device is a network device in a scenario of uplink transmission, and activating the target pilot element, indicated by the target pilot position information, on the RIS comprises:
activating the target pilot element by the network device based on the target pilot position information.

8. The method according to claim 7, wherein activating the target pilot element by the network device based on the target pilot position information comprises:
instructing the RIS to activate the target pilot element by transmitting the target pilot position information to the RIS through first signaling; or,
determining the target pilot element based on the target pilot position information, and transmitting an activation instruction to the RIS, wherein the activation instruction is configured to instruct to activate the target pilot element.

9. The method according to claim 6, wherein the communication device is a terminal device in a scenario of downlink transmission, and activating the target pilot element, indicated by the target pilot position information, on the RIS comprises:
transmitting the target pilot position information to a network device by the terminal device through second signaling, wherein the target pilot position information is configured to instruct the network device to activate the target pilot element based on the target pilot position information.

10. The method according to claim 6, wherein after activating the target pilot element, indicated by the target pilot position information, on the RIS, the method further comprises:
receiving a target pilot signal transmitted by the target pilot element, and obtaining second channel state information by performing channel estimation based on the target pilot signal.

11. The method according to claim 10, wherein after obtaining the second channel state information, the method further comprises:
determining target full-element channel state information of the RIS based on the second channel state information.

12. A method for determining pilot position information, performed by an RIS, comprising:
transmitting an initial pilot signal to a communication device, wherein the initial pilot signal is configured to obtain first channel state information by performing channel estimation by the communication device, and target pilot position information of the RIS is obtained by inputting the first channel state information into a trained target pilot position determination model.

13. The method according to claim 12, wherein transmitting the initial pilot signal to the communication device comprises:
transmitting the initial pilot signal to the communication device through an activated initial pilot element on the RIS.

14. The method according to claim 12, wherein after transmitting the initial pilot signal to the communication device, the method further comprises:
activating a target pilot element indicated by the target pilot position information.

15. The method according to claim 14, wherein activating the target pilot element indicated by the target pilot position information comprises:
receiving activation configuration information, re-configuring an active element of the RIS based on the activation configuration information, and activating the target pilot element.

16. The method according to any one of claim 14, wherein after activating the target pilot element indicated by the target pilot position information, the method further comprises:
transmitting a target pilot signal to the communication device based on the target pilot element, wherein the target pilot signal is configured to obtain second channel state information by performing channel estimation.

17-19. (canceled)

20. A device, comprising:
a memory, wherein the memory stores a computer program, and
one or more processors, wherein the processors collectively execute the computer program and cause the device to act as a communication device and perform the method according to claim 1.

21. A device, comprising
and a memory, wherein the memory stores a computer program, and
one or more processors, wherein the one or more processors collectively execute the computer program and cause the device to act as a communication device and perform the method according to claims.

22. A device, comprising
memory, wherein the memory stores a computer program, and
one or more processors, where the one or more processors collectively execute the computer program and causes the device to act as an RIS and perform the method according to claim 12.

23-25. (canceled)

26. A non-transitory computer-readable storage medium, configured to store an instruction, wherein when the instruction executed by a communication device, cause the communication device to perform the method according to claim 1.

27-28. (canceled)
